(19) United States
(12) Patent Application Publication
(10) Pub. No.: US 2024/0422635 A1
(43) Pub. Date: Dec. 19, 2024

(54) MITIGATING CONTINUOUS HANDOVER OR REDIRECTION FAILURE

(71) Applicant: QUALCOMM Incorporation, San Diego, CA (US)

(72) Inventors: Kedar PATANKAR, Hyderabad (IN); Bapineedu Chowdary GUMMADI, Hyderabad (IN)

(21) Appl. No.: 18/334,087

(22) Filed: Jun. 13, 2023

(51) Int. Cl. H04W 36/00; H04W 48/02

(52) U.S. Cl. CPC H04W 36/0085; H04W 36/0058; H04W 48/02

(57) ABSTRACT

Various aspects of the present disclosure generally relate to wireless communication. In some aspects, a user equipment (UE) may receive, prior to expiration of a barred cell timer that is associated with a barred cell, a measurement configuration that indicates to measure a frequency that is associated with the barred cell. The UE may compute that a signal metric associated with the frequency and the barred cell satisfies a quality threshold. The UE may selectively refrain from transmitting the signal metric based at least in part on a state of the barred cell timer. Numerous other aspects are described.

### FIELD OF THE DISCLOSURE

Aspects of the present disclosure generally relate to wireless communication and to techniques and apparatuses for mitigating continuous handover or redirection failure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communications at a user equipment (UE). The apparatus may include a processor, memory coupled with the processor, and instructions stored in the memory. The instructions may be executable by the processor to cause the apparatus to receive, prior to expiration of a barred cell timer that is associated with a barred cell, a measurement configuration that indicates to measure a frequency that is associated with the barred cell. The instructions may be executable by the processor to cause the apparatus to compute that a signal metric associated with the frequency and the barred cell satisfies a quality threshold. The instructions may be executable by the processor to cause the apparatus to selectively refrain from transmitting the signal metric based at least in part on a state of the barred cell timer.

Some aspects described herein relate to an apparatus for wireless communications at a UE. The apparatus may include a processor, memory coupled with the processor, and instructions stored in the memory. The instructions may be executable by the processor to cause the apparatus to receive an indication of a forbidden tracking area code (TAC). The instructions may be executable by the processor to cause the apparatus to receive a measurement configuration that indicates to measure at least one frequency associated with a cell. The instructions may be executable by the processor to cause the apparatus to selectively compute that a signal metric associated with the frequency and the cell satisfies a quality threshold. The instructions may be executable by the processor to cause the apparatus to refrain from transmitting the signal metric associated with the frequency and the cell based at least in part on the cell being associated with the forbidden TAC.

Some aspects described herein relate to a method of wireless communication performed by a UE. The method may include receiving, prior to expiration of a barred cell timer that is associated with a barred cell, a measurement configuration that indicates to measure a frequency that is associated with the barred cell. The method may include computing that a signal metric associated with the frequency and the barred cell satisfies a quality threshold. The method may include selectively refraining from transmitting the signal metric based at least in part on a state of the barred cell timer.

Some aspects described herein relate to a method of wireless communication performed by a UE. The method may include receiving an indication of a forbidden TAC. The method may include receiving a measurement configuration that indicates to measure at least one frequency associated with a cell. The method may include selectively computing that a signal metric associated with the frequency and the cell satisfies a quality threshold. The method may include refraining from transmitting the signal metric associated with the frequency and the cell based at least in part on the cell being associated with the forbidden TAC.

Some aspects described herein relate to a non-transitory computer-readable medium that stores a set of instructions for wireless communication by a UE. The set of instructions, when executed by one or more processors of the UE, may cause the UE to receive, prior to expiration of a barred cell timer that is associated with a barred cell, a measurement configuration that indicates to measure a frequency that is associated with the barred cell. The set of instructions, when executed by one or more processors of the UE, may cause the UE to compute that a signal metric associated with the frequency and the barred cell satisfies a quality threshold. The set of instructions, when executed by one or more processors of the UE, may cause the UE to selectively refrain from transmitting the signal metric based at least in part on a state of the barred cell timer.

Some aspects described herein relate to a non-transitory computer-readable medium that stores a set of instructions for wireless communication by a UE. The set of instructions, when executed by one or more processors of the UE, may cause the UE to receive an indication of a forbidden TAC. The set of instructions, when executed by one or more processors of the UE, may cause the UE to receive a measurement configuration that indicates to measure at least one frequency associated with a cell. The set of instructions, when executed by one or more processors of the UE, may cause the UE to selectively compute that a signal metric associated with the frequency and the cell satisfies a quality threshold. The set of instructions, when executed by one or more processors of the UE, may cause the UE to refrain from transmitting the signal metric associated with the frequency and the cell based at least in part on the cell being associated with the forbidden TAC.

Some aspects described herein relate to an apparatus for wireless communication. The apparatus may include means for receiving, prior to expiration of a barred cell timer that is associated with a barred cell, a measurement configuration that indicates to measure a frequency that is associated with the barred cell. The apparatus may include means for computing that a signal metric associated with the frequency and the barred cell satisfies a quality threshold. The apparatus may include means for selectively refraining from transmitting the signal metric based at least in part on a state of the barred cell timer.

Some aspects described herein relate to an apparatus for wireless communication. The apparatus may include means for receiving an indication of a forbidden TAC. The apparatus may include means for receiving a measurement configuration that indicates to measure at least one frequency associated with a cell. The apparatus may include means for selectively computing that a signal metric associated with the frequency and the cell satisfies a quality threshold. The apparatus may include means for refraining from transmitting the signal metric associated with the frequency and the cell based at least in part on the cell being associated with the forbidden TAC.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of make-before-break handover, in accordance with the present disclosure.

FIG. 4 is a diagram illustrating an example of a wireless communication process between a source network node and a UE, in accordance with the present disclosure.

FIG. 5 is a diagram illustrating an example of a wireless communication process between a source network node and a UE, in accordance with the present disclosure.

FIG. 6 is a diagram illustrating an example process performed, for example, by a UE, in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

In some aspects, a user equipment (UE) may report a signal metric that is associated with disallowed network node and/or a disallowed cell, such as a signal metric that is associated with a barred cell and/or a cell associated with a forbidden tracking area code (TAC). To illustrate, a source network node may transmit a measurement configuration that indicates to perform a measurement that is based at least in part on a disallowed cell. In some aspects, reporting a signal metric that is associated with a disallowed network node and/or a disallowed cell may result in a UE performing continuous handovers and/or redirections. To illustrate, the UE may transmit a signal metric that is associated with disallowed cell to the source network node based at least in part on the signal metric satisfying a quality threshold, and the source network node may instruct the UE to perform a handover to the disallowed network node and/or the disallowed cell. However, the UE may attempt to acquire access to the disallowed network node and/or disallowed cell, and fail. Accordingly, the UE may retain a connection with the source network node, and the process may repeat.

The repeated attempts of failed handovers and/or redirections to a disallowed network node and/or disallowed cell may result in increased signaling overhead at the UE, disrupted service at the UE, and/or decreased performance (e.g., reduced data throughput and/or increased data transfer latencies) at the UE. Alternatively, or additionally, the repeated attempts of failed handovers and/or redirections may result in increased transmission power levels by the UE and drain a battery life of the UE more quickly.

Various aspects relate generally to mitigating continuous handover or redirection failure. Some aspects more specifically relate to a UE autonomously refraining from transmitting a signal metric that is associated with a disallowed cell and/or a disallowed network node, such as a barred cell and/or a cell that is associated with a forbidden TAC. In some examples, a UE may receive, prior to expiration of a barred cell timer that is associated with a barred cell, a measurement configuration that indicates to measure a frequency that is associated with the barred cell. The UE may compute that a signal metric associated with the frequency and the barred cell satisfies a quality threshold. However, based at least in part on a state of the barred cell timer, the UE may selectively refrain from transmitting the signal metric.

Alternatively, or additionally, in other examples, a UE may receive an indication of a forbidden TAC, and the forbidden TAC may be associated with one or more cells. The UE may receive a measurement configuration that indicates to measure at least one frequency associated with a cell that is associated with the forbidden TAC. That is, the UE may receive an instruction to generate a signal metric that is based at least in part on at least one frequency that is associated with a cell included in the forbidden TAC. The UE may compute that the signal metric satisfies a quality threshold, but refrain from transmitting the signal metric based at least in part on the cell (and/or a frequency associated with the cell) being associated with the forbidden TAC. As one example, the UE may recover the indication of the forbidden TAC at a non-stratum access (NAS) layer of a protocol stack, and the NAS layer of the protocol stack may forward the indication of the forbidden TAC to a radio resource control (RRC) layer of the protocol stack to mitigate the transmission of a signal metric that is associated with the forbidden TAC.

Particular aspects of the subject matter described in this disclosure can be implemented to realize one or more of the following potential advantages. In some examples, by refraining from transmitting and/or reporting a signal metric that is associated with a disallowed network node and/or disallowed cell, the described techniques can be used by a UE to mitigate continuous handovers and/or redirections. That is, by refraining to report a signal metric associated with the disallowed network node and/or disallowed cell (e.g., despite the signal metric satisfying a quality threshold), the UE may mitigate a source network node selecting the cell and, subsequently, the UE receiving, an instruction to perform a handover and/or redirection to the disallowed cell. Mitigating repeated handovers and/or redirections to disallowed network nodes and/or disallowed cells may reduce signaling overhead at the UE, mitigate disrupted service at the UE, and/or increase performance (e.g., increase data throughput and/or decrease data transfer latencies) at the UE. Alternatively, or additionally, mitigating the repeated handovers and/or redirections may preserve and/or extend a battery life of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

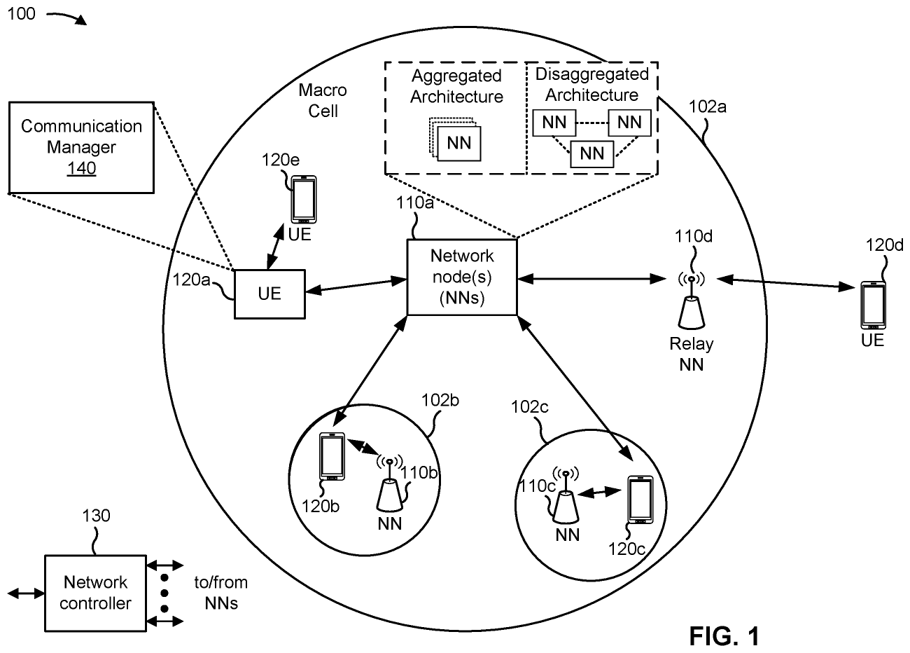

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 May include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive, prior to expiration of a barred cell timer that is associated with a barred cell, a measurement configuration that indicates to measure a frequency that is associated with the barred cell; compute that a signal metric associated with the frequency and the barred cell satisfies a quality threshold; and selectively refrain from transmitting the signal metric based at least in part on a state of the barred cell timer.

Alternatively or additionally, as described in more detail elsewhere herein, the communication manager 140 may receive an indication of a forbidden TAC; receive a measurement configuration that indicates to measure at least one frequency associated with a cell; selectively compute that a signal metric associated with the frequency and the cell satisfies a quality threshold; and refrain from transmitting the signal metric associated with the frequency and the cell based at least in part on the cell being associated with the forbidden TAC. Additionally, or alternatively, the communication manager 140 may perform one or more other operations described herein.

As indicated above, FIG. 1 is provided as an example. Other examples may differ from what is described with regard to FIG. 1.

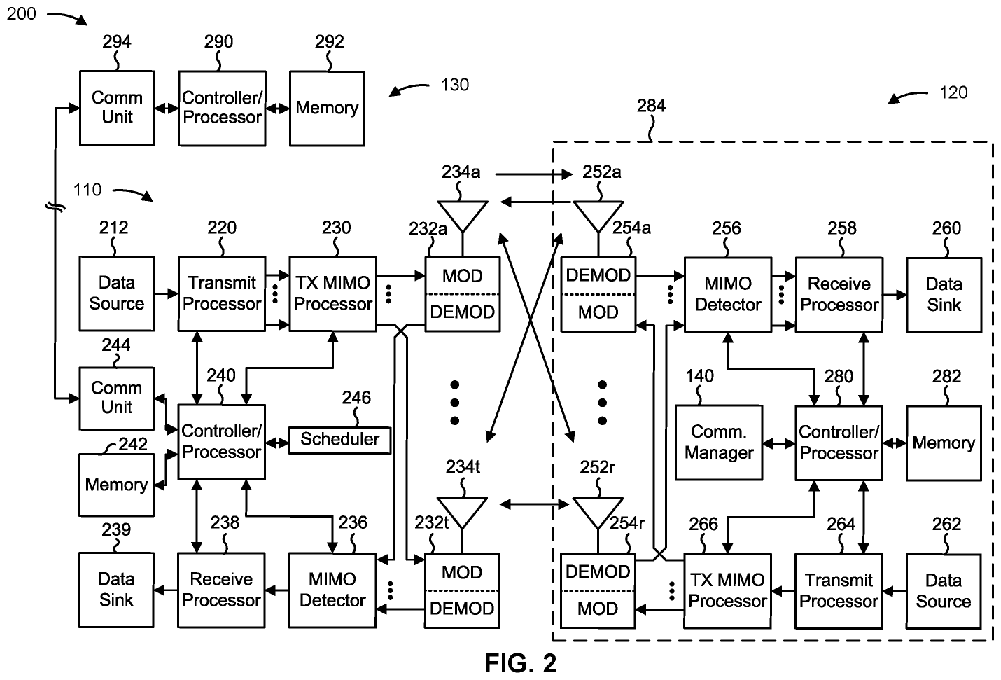

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

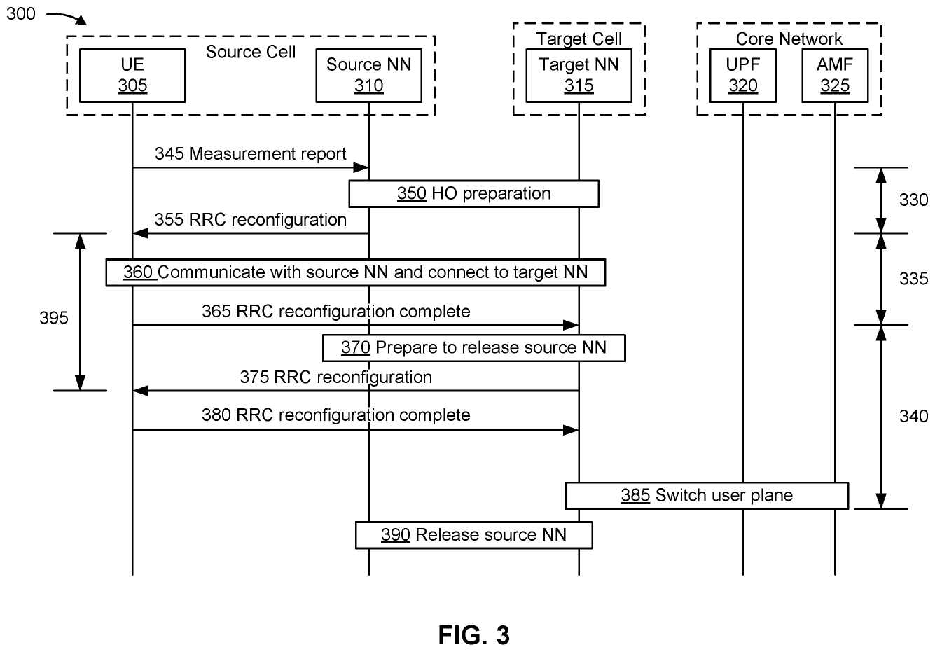

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

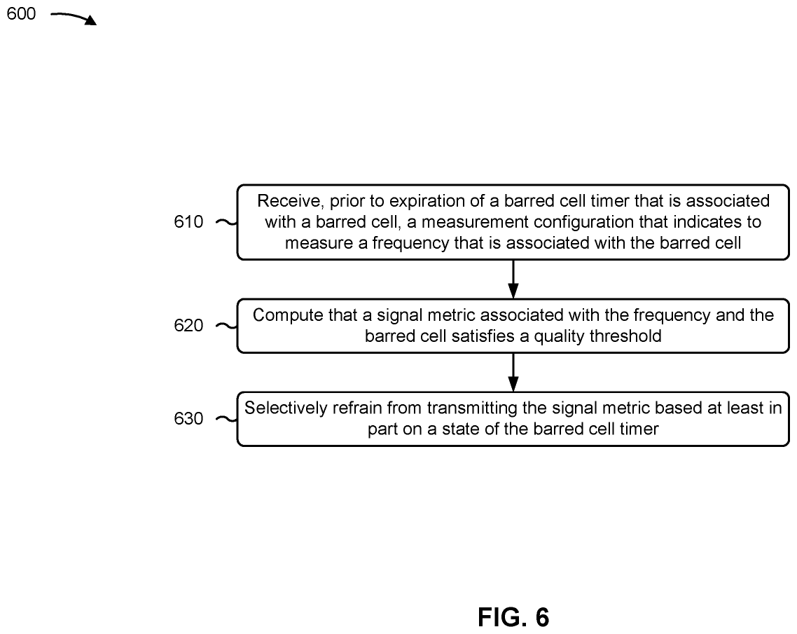

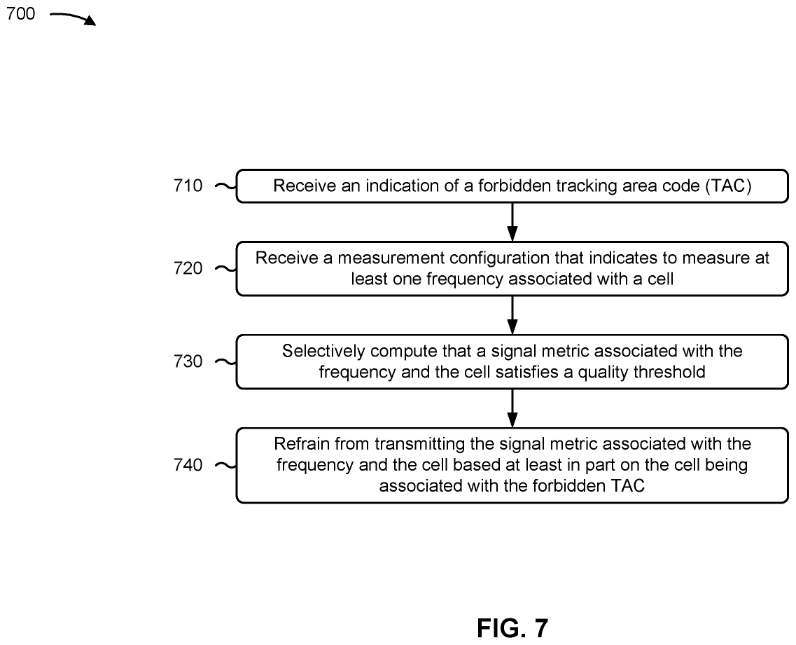

The controller/processor 240 of the network node 110, the controller/processor 280 of the UE 120, and/or any other component(s) of FIG. 2 may perform one or more techniques associated with mitigating continuous handover or redirection failure, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving, prior to expiration of a barred cell timer that is associated with a barred cell, a measurement configuration that indicates to measure a frequency that is associated with the barred cell; means for computing that a signal metric associated with the frequency and the barred cell satisfies a quality threshold; and/or means for selectively refraining from transmitting the signal metric based at least in part on a state of the barred cell timer.

Alternatively, or additionally, the UE includes means for receiving an indication of a forbidden TAC; means for receiving a measurement configuration that indicates to measure at least one frequency associated with a cell; means for selectively computing that a signal metric associated with the frequency and the cell satisfies a quality threshold; and/or means for refraining from transmitting the signal metric associated with the frequency and the cell based at least in part on the cell being associated with the forbidden TAC. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of make-before-break handover, in accordance with the present disclosure.

As shown in FIG. 3, a make-before-break (MBB) handover procedure may involve a UE 305, a source network node 310, a target network node 315, a user plane function (UPF) device 320, and an access and mobility management function (AMF) device 325. In an MBB handover procedure, the UE 305 may establish a connection with the target network node 315 prior to breaking a connection with the source network node 310. Other examples of handover procedures may include a break-before-make (BBM) handover procedure in which the UE 305 breaks a connection with the source network node 310 prior to forming a connection with the target network node 315. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 305 may correspond to the UE 120 described elsewhere herein. The source network node 310 and/or the target network node 315 may correspond to the network node 110 described elsewhere herein. The UPF device 320 and/or the AMF device 325 may correspond to the network controller 130 described elsewhere herein. The UE 305 and the source network node 310 may be connected (e.g., may have an RRC connection) via a serving cell or a source cell, and the UE 305 may undergo a handover to the target network node 315 via a target cell. The UPF device 320 and/or the AMF device 325 may be located within a core network. The source network node 310 and the target network node 315 may be in communication with the core network for mobility support and user plane functions. The MBB handover procedure may include an enhanced MBB (eMBB) handover procedure.

As shown, the MBB handover procedure may include a handover preparation phase 330, a handover execution phase 335, and a handover completion phase 340. During the handover preparation phase 330, the UE 305 may report measurements that cause the source network node 310 and/or the target network node 315 to prepare for handover and trigger execution of the handover. During the handover execution phase 335, the UE 305 may execute the handover by performing a random access procedure with the target network node 315 and establishing an RRC connection with the target network node 315. During the handover completion phase 340, the source network node 310 may forward stored communications associated with the UE 305 to the target network node 315, and the UE 305 may be released from a connection with the source network node 310.

As shown by reference number 345, the UE 305 may perform one or more measurements, and may transmit a measurement report to the source network node 310 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 310 may use the measurement report to determine whether to trigger a handover to the target network node 315. For example, if one or more measurements satisfy a condition, then the source network node 310 may trigger a handover of the UE 305 to the target network node 315.

In some aspects, the UE 305 may perform a measurement and/or generate a measurement report based at least in part on receiving a measurement configuration from the source network node 310. For example, the source network node 310 may indicate, by way of the measurement configuration, one or more parameters associated with performing the measurement(s), such as any combination of a frequency location, a time location, and/or a sub-carrier offset. Alternatively, and/or additionally, the source network node 310 may indicate, as a parameter associated with performing a measurement, one or more cells, such as by indicating a physical cell identify (PCI) in the measurement configuration. To illustrate, the source network node 310 may indicate a PCI associated with a neighbor cell (e.g., the target network node 315).

As shown by reference number 350, the source network node 310 and the target network node 315 may communicate with one another to prepare for a handover of the UE 305. As part of the handover preparation, the source network node 310 may transmit a handover request to the target network node 315 to instruct the target network node 315 to prepare for the handover. The source network node 310 may communicate RRC context information associated with the UE 305 and/or configuration information associated with the UE 305 to the target network node 315. The target network node 315 may prepare for the handover by reserving resources for the UE 305. After reserving the resources, the target network node 315 may transmit an acknowledgement (ACK) to the source network node 310 in response to the handover request.

As shown by reference number 355, the source network node 310 may transmit an RRC reconfiguration message to the UE 305. The RRC reconfiguration message may include a handover command instructing the UE 305 to execute a handover procedure from the source network node 310 to the target network node 315. The handover command may include information associated with the target network node 315, such as a random access channel (RACH) preamble assignment for accessing the target network node 315. Reception of the RRC reconfiguration message, including the handover command, by the UE 305 may trigger the start of the handover execution phase 335.

As shown by reference number 360, during the handover execution phase 335 of the MBB handover, the UE 305 may execute the handover by performing a random access procedure with the target network node 315 (e.g., including synchronization with the target network node 315) while continuing to communicate with the source network node 310. For example, while the UE 305 is performing the random access procedure with the target network node 315, the UE 305 may transmit uplink data, uplink control information, and/or an uplink reference signal (e.g., a sounding reference signal) to the source network node 310, and/or may receive downlink data, downlink control information, and/or a downlink reference signal from the source network node 310.

As shown by reference number 365, upon successfully establishing a connection with the target network node 315 (e.g., via a random access procedure), the UE may transmit an RRC reconfiguration completion message to the target network node 315. Reception of the RRC reconfiguration message by the target network node 315 may trigger the start of the handover completion phase 340.

As shown by reference number 370, the source network node 310 and the target network node 315 may communicate with one another to prepare for release of the connection between the source network node 310 and the UE 305. In some aspects, the target network node 315 may determine that a connection between the source network node 310 and the UE 305 is to be released, such as after receiving the RRC reconfiguration message from the UE 305. In this case, the target network node 315 may transmit a handover connection setup completion message to the source network node 310. The handover connection setup completion message may cause the source network node 310 to stop transmitting data to the UE 305 and/or to stop receiving data from the UE 305. Additionally, or alternatively, the handover connection setup completion message may cause the source network node 310 to forward communications associated with the UE 305 to the target network node 315 and/or to notify the target network node 315 of a status of one or more communications with the UE 305. For example, the source network node 310 may forward, to the target network node 315, buffered downlink communications (e.g., downlink data) for the UE 305 and/or uplink communications (e.g., uplink data) received from the UE 305. Additionally, or alternatively, the source network node 310 may notify the target network node 315 regarding a packet data convergence protocol (PDCP) status associated with the UE 305 and/or a sequence number to be used for a downlink communication with the UE 305.

As shown by reference number 375, the target network node 315 may transmit an RRC reconfiguration message to the UE 305 to instruct the UE 305 to release the connection with the source network node 310. Upon receiving the instruction to release the connection with the source network node 310, the UE 305 may stop communicating with the source network node 310. For example, the UE 305 may refrain from transmitting uplink communications to the source network node 310 and/or may refrain from monitoring for downlink communications from the source network node 310.

As shown by reference number 380, the UE may transmit an RRC reconfiguration completion message to the target network node 315 to indicate that the connection between the source network node 310 and the UE 305 is being released or has been released.

As shown by reference number 385, the target network node 315, the UPF device 320, and/or the AMF device 325 may communicate to switch a user plane path of the UE 305 from the source network node 310 to the target network node 315. Prior to switching the user plane path, downlink communications for the UE 305 may be routed through the core network to the source network node 310. After the user plane path is switched, downlink communications for the UE 305 may be routed through the core network to the target network node 315. Upon completing the switch of the user plane path, the AMF device 325 may transmit an end marker message to the source network node 310 to signal completion of the user plane path switch. As shown by reference number 390, the target network node 315 and the source network node 310 may communicate to release the source network node 310.

As part of the MBB handover procedure, the UE 305 may maintain simultaneous connections with the source network node 310 and the target network node 315 during a time period 395. The time period 395 may start at the beginning of the handover execution phase 335 (e.g., upon reception by the UE 305 of a handover command from the source network node 310) when the UE 305 performs a random access procedure with the target network node 315. The time period 395 may end upon release of the connection between the UE 305 and the source network node 310 (e.g., upon reception by the UE 305 of an instruction, from the target network node 315, to release the source network node 310). By maintaining simultaneous connections with the source network node 310 and the target network node 315, the handover procedure can be performed with zero or a minimal interruption to communications, thereby reducing latency.

In some aspects, the UE 305 may report, via a measurement report, a signal metric that is associated with a barred cell, a barred frequency, and/or a cell associated with a forbidden TAC. To illustrate, the source network node 310 may transmit a measurement configuration that indicates to perform a measurement on any combination of a barred cell, a cell associated with a forbidden TAC, a frequency associated with the barred cell, and/or a frequency associated with the cell of the forbidden TAC. “Barred cell” may refer to a cell that is inaccessible or unavailable for use by a UE. As one example, a network may bar a cell from use by the UE 305 based at least in part on network congestion at the cell, maintenance and/or upgrade procedures being performed at the cell, security measures at the cell, and/or policy-based restrictions associated with the cell. As another example, the UE 305 May autonomously identify a cell as a barred cell based at least in part on various characteristics of the cell, such as a signal metric that fails a quality threshold, a corrupted system information block (SIB), and/or a failed access attempt. Accordingly, in some aspects, a UE may not be permitted to connect to, and/or access services from, a barred cell. “TAC” may refer to a group of cells within a wireless network. A TAC may be used by the wireless network to track a location of a UE moving from one cell to another cell (e.g., within the group of cells associated with the TAC). “Forbidden TAC” may refer to a group of cells and/or a specific region associated with a coverage area provided by the group of cells that is forbidden to one or more UEs. That is, the UE(s) may not be allowed to register and/or connect to the cells within the group of cells associated with the TAC. To illustrate, a UE that attempts to register in a forbidden TAC (e.g., via a network node and/or cell included in the forbidden TAC) may be denied access to the wireless network and, subsequently may be unable to initiate and/or receive calls, send and/or receive text messages, and/or use data services that are provided by one or more network nodes and/or cells associated with the forbidden TAC.

Reporting a signal metric that is associated with a barred cell and/or a forbidden TAC may result in a UE (e.g., the UE 305) performing continuous handovers and/or redirections. To illustrate, based at least in part on a measurement configuration from a source network node (e.g., the source network node 310), the UE may generate a Layer 1 signal metric that is associated with a barred cell and/or forbidden cell, may determine that the Layer 1 signal metric satisfies a quality threshold (e.g., a power threshold), and/or may transmit the Layer 1 signal metric to the source network node in a measurement report. In some aspects, the source network node may instruct the UE to perform a handover and/or a redirection to a target network node and/or cell that is associated with the Layer 1 signal metric, and the UE may attempt to acquire access to the target network node and/or cell. Because the signal metric is based at least in part on a barred cell and/or a cell associated with a forbidden TAC, the acquisition may fail, and the UE may retain a connection with the source network node. In some aspects, however, the process may repeat.

To illustrate, based at least in part on failing to acquire access to a target network node and/or cell as part of a handover, the UE may start a barred cell timer that is associated with the target network node and/or cell. That is, the UE may tag the target network node and/or cell as a barred cell, and start the barred cell timer with a long expiration duration (e.g., a 5 minute duration and/or a 300 second duration). Prior to expiration of the barred cell timer, the UE may be disallowed from accessing the target network node and/or cell. In some aspects, however, a measurement configuration from the source network node may indicate to generate a measurement based at least in part on the barred cell. Accordingly, the UE may repeatedly generate and/or transmit a Layer 1 signal metric associated with the barred cell to the source network node, and the source network node may repeatedly instruct the UE to perform a handover and/or redirection to the barred cell, resulting in a failed handover and/or a failed redirection by the UE. The source network node and the UE may repeat this process until expiration of the barred cell timer, and the UE is allowed to access the (no longer) barred cell.

As another example, the UE may be disallowed from camping on a network node and/or cell that is associated with a forbidden TAC. In some aspects, information that indicates a forbidden cell and/or a forbidden TAC may be extracted and/or obtained by a higher protocol layer in a protocol stack of the UE (e.g., a NAS protocol layer) instead of a lower protocol layer in the protocol stack (e.g., an RRC protocol layer) that generates signal metrics. Accordingly, without the information that indicates a target network node and/or cell is part of the forbidden TAC, the lower protocol layer may repeatedly transmit a measurement report that includes the Layer 1 signal metric to the source network node, the source network node may repeatedly instruct the UE to perform a handover and/or redirection to the target network node and/or cell that is associated with the forbidden TAC, and the handover and/or redirection may repeatedly fail. The repeated attempts of failed handovers and/or redirections to a barred cell and/or a cell included in a forbidden TAC may result in increased signaling overhead at the UE, disrupted service at the UE, and/or decreased performance (e.g., reduced data throughput, increased data transfer latencies, and/or reduced signal quality) at the UE. Some techniques and apparatuses described herein provide mitigating

continuous handover or redirection failure. In some aspects, a UE (e.g., a UE 120) may receive, prior to expiration of a barred cell timer that is associated with a barred cell, a measurement configuration that indicates to measure a frequency that is associated with the barred cell. The UE may compute that a signal metric associated with the frequency and the barred cell satisfies a quality threshold. However, based at least in part on a state of the barred cell timer, the UE may selectively refrain from transmitting the signal metric. To illustrate, although the signal metric satisfies the quality threshold, the UE may refrain from transmitting the signal metric prior to expiration of the barred cell timer. Alternatively, or additionally, based at least in part on expiration of the barred cell time, the UE may transmit the signal metric as described below.

In some aspects, a UE may receive an indication of a forbidden TAC, and the forbidden TAC may be associated with one or more cells. The UE may receive a measurement configuration that indicates to measure at least one frequency associated with a cell that is associated with the forbidden TAC. That is, the UE may receive an instruction to generate a signal metric that is based at least in part on at least one frequency that is associated with a cell included in the forbidden TAC. The UE may compute that the signal metric satisfies a quality threshold. However, although the signal metric satisfies the quality threshold, the UE may refrain from transmitting the signal metric based at least in part on the cell (and/or a frequency associated with the cell) being associated with the forbidden TAC. As one example, the UE may recover the indication of the forbidden TAC at a NAS layer of a protocol stack, and the NAS layer of the protocol stack may forward the indication of the forbidden TAC to an RRC layer of the protocol stack. Accordingly, by way of the NAS layer forwarding the indication to the RRC layer, the RRC layer of a protocol stack at the UE may refrain from transmitting (e.g., to the source network node) the signal metric that is associated with the cell of the forbidden TAC.

By refraining from transmitting and/or reporting a signal metric that is associated with a barred cell and/or a cell included in a forbidden TAC, a UE may mitigate continuous handovers and/or redirections. That is, by refraining to report a signal metric associated with a barred cell and/or a cell included in the forbidden TAC (e.g., despite the signal metric satisfying a quality threshold), the UE may mitigate a source network node selecting the cell and, subsequently, the UE receiving, an instruction to perform a handover and/or redirection to the disallowed cell. Mitigating repeated handovers and/or redirections to disallowed cells may reduce signaling overhead at the UE, mitigate disrupted service at the UE, and/or increase performance (e.g., increase data throughput, decrease data transfer latencies, and/or increase signal quality) at the UE.

As indicated above, FIG. 3 is provided as an example. Other examples may differ from what is described with respect to FIG. 3.

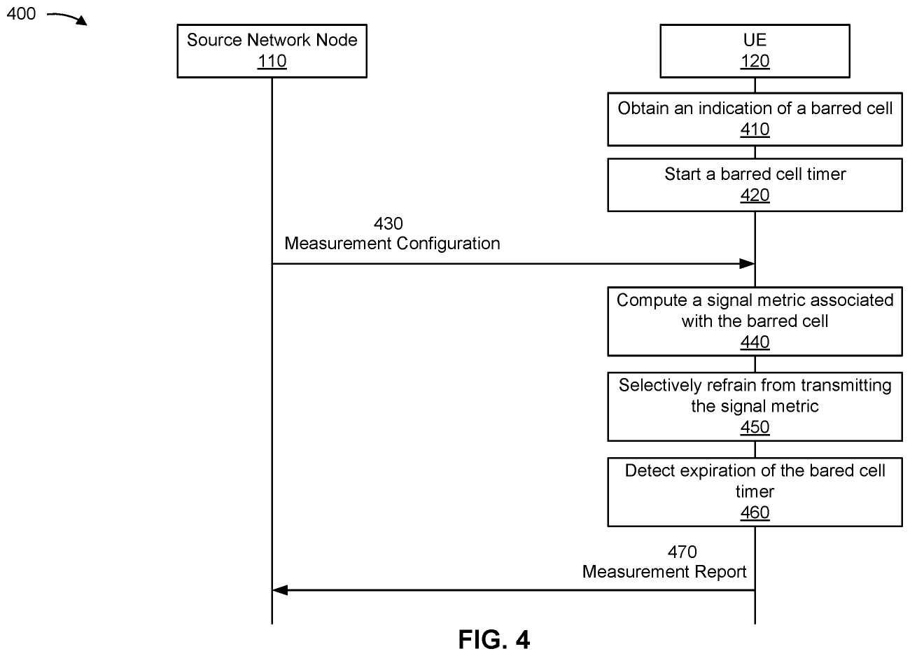

FIG. 4 is a diagram illustrating an example 400 of a wireless communication process between a source network node 110 (e.g., the network node 110) and a UE (e.g., the UE 120), in accordance with the present disclosure.

As shown by reference number 410, the UE 120 may obtain an indication of a barred cell. In some aspects, the UE 12—may obtain the indication of a barred cell autonomously. As one example, the UE 120 may attempt, and fail, access to another network node (e.g., another cell) than the source network node 110 that is serving the UE 120. That is, the failed access and/or the failed attempt to acquire access may indicate that the other network node is a barred cell. Based at least in part on the failed access and/or the failed attempt to acquire access to the other network node, the UE 120 may tag the other network node 110 as a barred cell, such as by adding any combination of a PCI, an evolved universal mobile telecommunication system terrestrial radio access absolute radio frequency channel number (EARFCN) associated with the cell, and/or an absolute radio frequency channel number (ARFCN) assigned to the other network node to an internal and/or local list of barred cells.

Alternatively, or additionally, the UE 120 may compute a signal metric based at least in part on a frequency associated with the other network node, and the signal metric may fail a quality threshold. To illustrate, the quality metric may be a Layer 1 RSRP metric that fails to satisfy a power threshold. Accordingly, the signal metric failing to satisfy the quality threshold may indicate, to the UE 120, that the other network node is a barred cell. Accordingly, the UE 120 may tag the other network node 110 as a barred cell based at least in part on the signal metric failing to satisfy the quality threshold. As yet another example, the UE 120 may receive an invalid SIB from the other network node, such as a SIB that includes incomplete and/or incorrect information. Accordingly, receiving an invalid SIB may indicate that the other network node is a barred cell, and the UE 120 may tag the other network node as a barred cell.

As shown by reference number 420, the UE 120 may start a barred cell timer with a duration of T_{barred}. T_{barred} may be any duration, such as 5 minutes and/or 300 seconds as described above. In some aspects, T_{barred} may be specified by and/or based at least in part on a communication standard.

As shown by reference number 430, the source network node 110 may transmit, and the UE 120 may receive, a measurement configuration that indicates to measure a frequency associated with the barred cell. As one example, the source network node 110 may transmit the measurement configuration in an RRC message. The measurement configuration may indicate to perform a measurement on any combination of frequency locations, time locations, sub-carrier offsets, and/or cells as described above. In some aspects, the source network node 110 may indicate, as part of the measurement configuration, a trigger event that is associated with triggering the generation and/or transmission of a measurement report that is based at least in part on the measurement configuration. Alternatively, or additionally, the trigger event may be implicit and/or defined by a communication standard. One example of a trigger event may be a power level change (e.g., in a received signal observed by the UE 120) that satisfies a trigger threshold. In some aspects, the source network node 110 may indicate a duration for a time-to-trigger timer that is associated with transmitting the measurement report. Alternatively, or additionally, the duration for the time-to-trigger timer may be specified by and/or based at least in part on a communication standard. The duration for the time-to-trigger timer may be represented as T_{trigger}. In other aspects, the source network node 110 may indicate a periodicity for the generation and/or transmission of the measurement report.

In the example 400, the source network node 110 transmits the measurement configuration after the UE 120 obtains an indication of a barred cell and after the UE 120 starts the barred cell timer, but other examples may include the network node 110 transmitting the measurement configuration before the UE obtains the indication of the barred cell and/or before the UE starts the barred cell timer. Alternatively, or additionally, the source network node 110 may repeatedly transmit updated and/or different measurement configurations.

As shown by reference number 440, the UE 120 may compute a signal metric that is associated with the barred cell and/or a frequency associated with the barred cell. As one example, prior to expiration of the barred cell timer, the UE 120 may identify a trigger event associated with generating a measurement report, such as a power level change as described above. Based at least in part on identifying the trigger event, the UE 120 may start a time-to-trigger timer that indicates when to generate and/or send a measurement report (e.g., at expiration of the time-to-trigger timer). To illustrate, based at least in part on identifying the trigger event, the UE 120 may start the time-to-trigger timer using a duration of T_{trigger}. Alternatively, or additionally, the UE 120 may compute one or more Layer 1 signal metrics (e.g., RSRP) based at least in part on the measurement configuration as described with regard to reference number 430, such as by computing a Layer 1 signal metric that is associated with the barred cell and/or a frequency of the barred cell, and start the time-to-trigger timer based at least in part on the Layer 1 signal metric satisfying a quality threshold.

As another example, prior to expiration of the barred cell timer, the UE 120 may periodically generate a signal metric (e.g., without identifying a trigger event). For instance, the measurement configuration may indicate a periodicity and/or may indicate a periodic measurement time. Accordingly, the UE 120 may generate the signal metric based at least in part on the barred cell and/or a frequency associated with the barred cell based at least in part on a periodicity indicated in the measurement configuration.

In some aspects, the UE 120 may evaluate the signal metric. To illustrate, the UE 120 may compare the signal metric to a quality threshold (e.g., a power level threshold) to determine whether the signal metric satisfies the quality threshold or fails to satisfy the quality threshold.

As shown by reference number 450, the UE 120 may selectively refrain from transmitting the signal metric that is associated with the barred cell based at least in part on a state of the barred cell timer. That is, the UE 120 may selectively refrain from transmitting a signal metric that satisfies the quality threshold based at least in part on the state of the barred cell timer. To illustrate, the state of the barred cell timer may be an active state (e.g., still running) or an expired state. Based at least in part on the barred cell timer having an active state, the UE 120 may refrain from transmitting the signal metric by refraining from transmitting an entirety of a measurement report that is associated with the measurement configuration. That is, the UE 120 may not transmit a measurement report associated with the measurement configuration based at least in part on the barred cell timer being active. Alternatively, or additionally, based at least in part on the barred cell timer having an active state, the UE 120 may generate the measurement report that is associated with the measurement configuration and omit the signal metric associated with the barred cell (and/or the frequency associated with the barred cell), from the measurement report. That is, the UE 120 may generate a measurement report that does not include a signal metric that is associated with the barred cell based at least in part on the barred cell timer being active.

As shown by reference number 460, the UE 120 may detect expiration of the barred cell timer. Based at least in part on the barred cell timer having an expired state, the UE 120 may add the signal metric to the measurement report. As one example, and as described above, the UE 120 may start a time-to-trigger timer at a time that is close to expiration of the barred cell timer. To illustrate, the UE 120 may start the barred cell timer at time t₀=0, and the barred cell timer may expire at time t₁=T_{barred}. In some aspects, the UE 120 may start a time-to-trigger timer at time t₂=T_{barred}−T_{trigger} or later such that the barred cell timer expires at a commensurate time (e.g., within a threshold) of the time-to trigger timer and/or earlier than the time-to-trigger timer. For example, the UE 120 may start the time-to-trigger timer based at least in part on the signal metric satisfying a quality threshold. Accordingly, the UE 120 may receive, prior to selectively refraining from transmitting the signal metric, an indication that the barred cell timer has expired. That is, the UE 120 may receive a notification (e.g., from the barred cell timer and/or an operating system at the UE 120) that indicates expiration of the barred cell timer. The UE 120 may receive the indication that the barred cell timer has expired prior to expiration of the time-to-trigger timer and/or at a commensurate time as the expiration of the time-to-trigger timer. The UE 120 may receive a second indication and/or notification associated with the expiration of the time-to-trigger timer in a similar manner as the indication and/or notification of the expiration of the barred cell timer. To illustrate, prior to a determination to selectively refrain from transmitting the signal metric, the UE 120 may receive a notification that the barred cell timer has expired. Accordingly, the UE 120 may add the signal metric (e.g., associated with the barred cell) to the measurement report based at least in part on expiration of the barred cell timer and the signal metric satisfying the quality threshold. Alternatively, or additionally, the UE 120 may transmit the measurement report (e.g., that includes the signal metric associated with the barred cell) based at least in part on expiration of the time-to-trigger timer as described with regard to reference number 470. While the example 400 includes the UE 120 detecting expiration of the barred cell timer, other examples may exclude the UE 120 detecting expiration of the barred cell timer, such as in examples associated with the UE transmitting a measurement report that excludes the signal metric.

As shown by reference number 470, the UE 120 may transmit, and the network node 110 may receive, a measurement report. As described above, the measurement report may not include the signal metric that is associated with the barred cell (and/or the frequency associated with the barred cell), such as in a first scenario associated with the barred cell timer having an active state. In other aspects, the measurement report may include the signal metric that is associated with the barred cell, such as in a second scenario associated with the barred cell timer having an expired state. To illustrate, the measurement report may include the signal metric based at least in part on UE 120 detecting expiration of the barred cell, detecting expiration of the time-to trigger timer, and the signal metric satisfying a quality threshold. As another example, the UE 120 may transmit the measurement report based at least in part on a periodicity. In some aspects, the UE 120 may transmit the measurement report based at least in part on receiving an indication that the time-to-trigger timer has expired, and the measurement report excludes and/or does not include the signal metric, such as in a scenario where the barred cell timer has not expired and/or the signal metric fails to satisfy the quality threshold.

While the UE 120 transmits a measurement report in the example 400, the UE 120 may refrain from transmitting an entirety of the measurement report in other examples. For instance, and as described above, the UE 120 may refrain from transmitting any portion and/or an entirety of the measurement report associated with the measurement configuration based at least in part on the barred cell timer having an active state. Accordingly, selectively refraining from transmitting the signal metric may include the UE 120 not transmitting the signal metric (e.g., by omitting the signal metric from a measurement report and/or refraining from transmitting any portion of the measurement report) in a first scenario associated with the barred cell timer having an active state, or the UE 120 transmitting the signal metric in a second scenario associated with the barred cell timer having an expired state.

By refraining from transmitting and/or reporting a signal metric that is associated with a barred cell, a UE may mitigate repeatedly receiving instructions to perform a handover and/or a redirection to the barred cell. Mitigating repeated handovers and/or redirections to a barred cell may reduce signaling overhead at the UE, mitigate disrupted service at the UE, and/or increase performance (e.g., increased data throughput, decreased data transfer latencies, and/or increased signal quality) at the UE.

As indicated above, FIG. 4 is provided as an example. Other examples may differ from what is described with regard to FIG. 4.

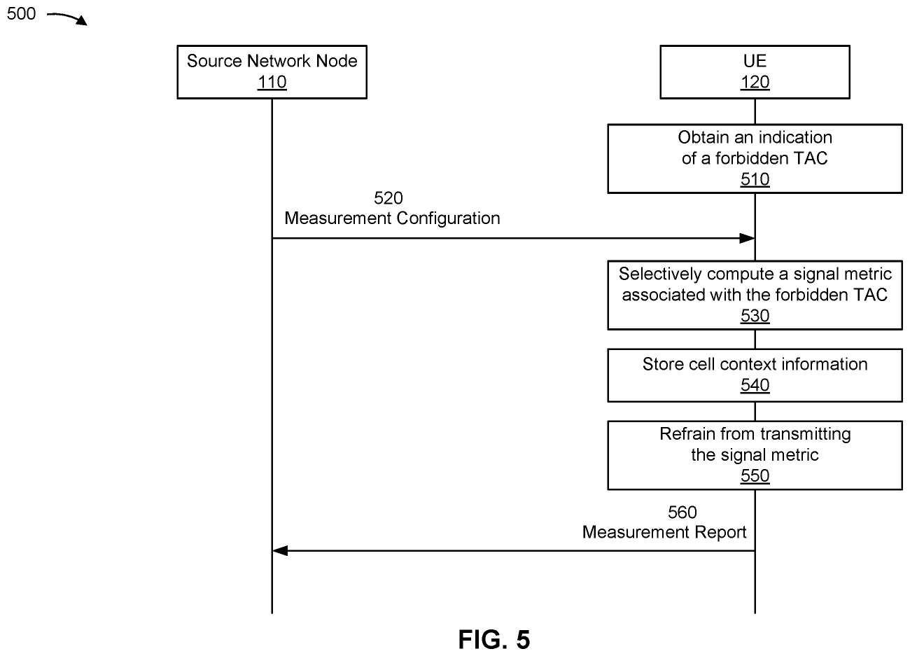

FIG. 5 is a diagram illustrating an example 500 of a wireless communication process between a source network node 110 (e.g., the network node 110) and a UE (e.g., the UE 120), in accordance with the present disclosure.

As shown by reference number 510, the UE 120 may obtain an indication of a forbidden TAC. As one example, a core network may transmit, by way of the source network node 110 and/or another network node, a tracking area update (TAU) message that indicates one or more forbidden TACs. To illustrate, the UE 120 may move into a new tracking area (TA) and request information associated with the TA. The core network node may transmit, by way of the source network node 110, the TAU message in response to the request from the UE 120. Alternatively, or additionally, the core network may broadcast, by way of one or more other network nodes associated with a forbidden TAC, an indication of a forbidden TAC information (e.g., a forbidden TAC and/or one or more cells identifiers of cells included in the forbidden TAC).

In some aspects, a NAS layer message may include the forbidden TAC information, and the NAS message may be directed to a NAS layer of a protocol stack at the UE 120. That is, a NAS layer of the UE 120 may recover the forbidden TAC information (e.g., that indicates one or more forbidden TACs and/or one or more cells included in a forbidden TAC) from the core network message. Accordingly, a protocol layer lower than the NAS layer, such as an RRC layer of the protocol stack, may pass the message to the NAS layer without recovering the forbidden TAC information. In some aspects, and based at least in part on recovering the forbidden TAC information, the NAS layer of the protocol stack may forward an indication of a forbidden TAC to the RRC layer of the protocol stack.

As shown by reference number 520, a source network node 110 serving the UE 120 may transmit, and the UE 120 may receive, a measurement configuration that indicates to measure a frequency associated with a cell that is associated and/or included in the forbidden TAC. In a similar manner as described with regard to FIG. 4, the source network node 110 may transmit the measurement configuration in an RRC message, and the measurement configuration may indicate to perform a measurement on any combination of frequency locations, time locations, sub-carrier offsets, and/or cells. Alternatively, or additionally, the measurement configuration may specify a trigger event and/or a periodicity associated with the generation and/or transmission of a measurement report.

In the example 500, the source network node 110 transmits the measurement configuration after the UE 120 obtains an indication of the forbidden TAC, but other examples may include the source network node 110 transmitting the measurement configuration before the UE obtains the indication of forbidden TAC. Alternatively, or additionally, the source network node 110 may repeatedly transmit updated and/or different measurement configurations.

As shown by reference number 530, the UE 120 may selectively compute a signal metric that is associated with the forbidden TAC, such as a signal metric that is based at least in part on a frequency associated with a cell that is included in the forbidden TAC. To illustrate, the UE 120 may compute the signal metric based at least in part on detecting a trigger event and/or a periodicity in a similar manner as described above with regard to FIG. 4. Alternatively, or additionally, the UE 120 may start a time-to-trigger timer that indicates when to generate and/or send a measurement report. However, in other aspects, the UE 120 may refrain from computing the signal metric, such as that described with regard to reference number 540.

In some aspects, an RRC layer of the UE 120 may compute the signal metric, such as a Layer 1 signal metric as described above. As part of generating the signal metric that is associated with the forbidden TAC, the UE 120 may evaluate the signal metric, such as by comparing the signal metric to a quality threshold to determine whether the signal metric satisfies the quality threshold or fails to satisfy the quality threshold.

As shown by reference number 540, the UE 120 may store cell context information. To illustrate, the RRC layer of the UE protocol stack may recover cell context information for the cell that is associated with the signal metric generated as described with regard to reference number 530, and/or may store the cell context information in memory at the UE 120 as at least part of forbidden TAC context information. That is, the UE 120 may store the context information in local memory based at least in part on the cell being associated and/or included in the forbidden TAC. Some non-limiting examples of cell context information may include one or more of a PCI associated with the cell, an EARFCN associated with the cell, and/or an ARFCN. The UE 120 may use the stored cell context information and/or the forbidden TAC context information to refrain from generating a signal metric that is associated with a forbidden TAC.

To illustrate, the UE 120 (e.g., by way of an RRC layer) may iteratively compute signal metrics, such as by iteratively computing signal metrics based at least in part on a periodicity indicated by a measurement configuration and/or based at least in part on identifying multiple trigger events. Accordingly, for each iteration of computing a signal metric, the UE 120 (e.g., by way of the RRC layer) may recover respective cell context information (e.g., first cell context information associated with a first cell during a first iteration and/or second cell context information that is associated with a second cell during a second iteration). In some aspects, an RRC layer of the UE 120 may recover the cell context information associated with a current cell and/or potential cell prior to computing a signal metric associated with the current cell and/or potential cell. The UE 120 may compare the cell context information associated with the potential cell to the forbidden TAC context information stored at the UE 120. In some aspects, the UE 120 may determine that the potential cell is associated with the forbidden TAC, such as by identifying that a PCI, an EARFCN, and/or an ARFCN associated with the potential cell is stored in the forbidden TAC context information. To illustrate, the PCI, the EARFCN, and/or the ARFCN associated with the potential cell may be the same context information from a prior cell measured by the UE 120 and/or stored in the forbidden TAC context information. Alternatively, or additionally, the potential cell may be a new cell (e.g., not previously measured by the UE 120) that the UE 120 identifies as being associated with the forbidden TAC, such as an RRC layer of the UE 120 identifying that the potential cell is part of the forbidden TAC based at least in part on an indication from the NAS layer of the protocol stack, and the UE 120 may store the context information of the potential cell as part of the forbidden TAC context information. Accordingly, the UE 120 may perform a comparison of the cell context information and the forbidden TAC context information to make a determination on whether the potential cell is associated with the forbidden TAC. The UE 120 may subsequently refrain from computing a signal metric that is associated with the potential cell (and as described with regard to reference number 530) based at least in part on the comparison and/or the determination, such as in a scenario associated with a determination that the potential cell is associated with the forbidden TAC.

As shown by reference number 550, the UE 120 may refrain from transmitting a signal metric that is associated with a forbidden TAC, such as a signal metric that is based at least in part on a frequency associated with a cell included in the forbidden TAC. That is, the UE 120 may refrain from transmitting a signal metric that satisfies a quality threshold based at least in part on the signal metric being associated with the forbidden TAC. To illustrate, and as described above, an RRC layer of the protocol stack may receive, from the NAS layer of the protocol stack, the indication of the forbidden TAC and/or an indication of one or more cells included in the forbidden TAC. Alternatively, or additionally, prior to transmitting a measurement report that includes the signal metric, the RRC layer of the protocol stack may recover information from a SIB associated with the cell and/or frequency being measured to determine if the cell is included in the forbidden TAC. For example, the UE 120 may generate, by way of the RRC layer, a signal metric that is associated with the barred cell and satisfies a quality threshold. Based at least in part on the signal metric satisfying the quality threshold and the indication from the NAS layer, the RRC layer may recover information from the SIB (e.g., a PCI, an EARFCN, and/or an ARFCN). In some aspects, the SIB may indicate an identifier associated with the signal metric being generated, such as a cell identifier and/or a TAC identifier, and the UE 120 may determine that the identifier indicated by the SIB is associated with the forbidden TAC (e.g., based at least in part on the indication from the NAS layer). That is, the UE 120 may determine that a cell associated with identifier and/or a TAC associated with the identifier is associated with the forbidden TAC. Accordingly, and in a similar manner as described above with regard to FIG. 4, the UE 120 may refrain from transmitting the signal metric that is associated with the forbidden TAC (e.g., the signal metric that is based at least in part on a frequency associated with a cell in the forbidden TAC). To illustrate, the UE 120 may refrain from transmitting an entirety of a measurement report that is associated with the measurement configuration, or may omit the signal metric that is associated with the forbidden TAC from the measurement report. Alternatively, or additionally, the UE 120 may refrain from generating the signal metric entirely as described above.

As shown by reference number 560, the UE 120 may transmit, and the network node 110 may receive, a measurement report. As one example, the UE 120 may transmit the measurement report based at least in part on receiving an indication that the time-to-trigger timer has expired. To illustrate, the UE 120 may transmit a measurement report that does not include the signal metric that is associated with the forbidden TAC in a similar manner as described above with regard to FIG. 4. That is, the UE 120 may omit the signal metric associated with the forbidden TAC from the measurement report. While the UE 120 transmits a measurement report in the example 500, other examples may include the UE 120 refraining from transmitting an entirety of the measurement report in other examples. For instance, in a similar manner as described above with regard to FIG. 4, the UE 120 may refrain from transmitting any portion of the measurement report associated with the measurement configuration based at least in part on the signal metric being associated with the forbidden TAC.

By refraining from transmitting and/or reporting a signal metric that is associated with a cell included in a forbidden TAC, a UE may mitigate repeatedly receiving instructions to perform a handover and/or a redirection to a cell included in the forbidden TAC. That is, by refraining to report a signal metric associated with a cell included in the forbidden TAC that satisfies a quality threshold, the UE may mitigate a source network node selecting the cell and, subsequently, the UE receiving, an instruction to perform a handover and/or redirection to the cell included in the forbidden TAC. Mitigating repeated handovers and/or redirections to a forbidden TAC may reduce signaling overhead at the UE, mitigate disrupted service at the UE, and/or increase performance (e.g., increased data throughput, decreased data transfer latencies, and/or increased signal quality) at the UE.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with mitigating continuous handover or redirection failure.

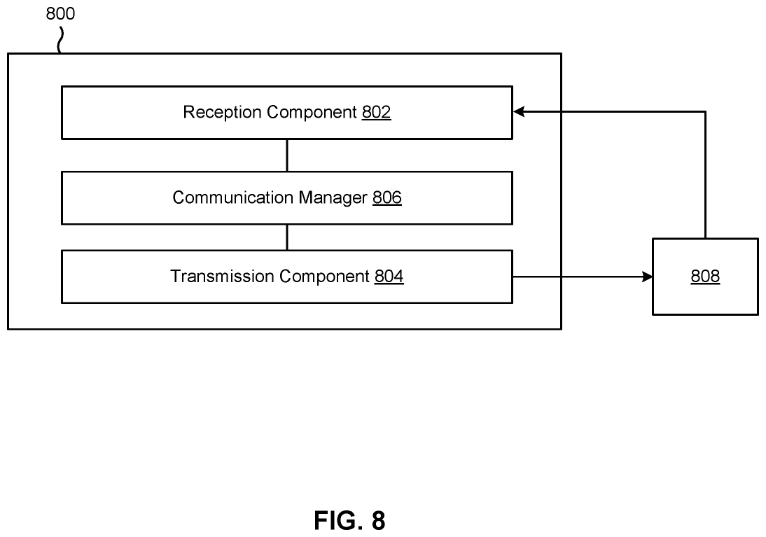

As shown in FIG. 6, in some aspects, process 600 may include receiving, prior to expiration of a barred cell timer that is associated with a barred cell, a measurement configuration that indicates to measure a frequency that is associated with the barred cell (block 610). For example, the UE (e.g., using reception component 802 and/or communication manager 806, depicted in FIG. 8) may receive, prior to expiration of a barred cell timer that is associated with a barred cell, a measurement configuration that indicates to measure a frequency that is associated with the barred cell, as described above.

As further shown in FIG. 6, in some aspects, process 600 may include computing that a signal metric associated with the frequency and the barred cell satisfies a quality threshold (block 620). For example, the UE (e.g., using communication manager 806, depicted in FIG. 8) may compute that a signal metric associated with the frequency and the barred cell satisfies a quality threshold, as described above.

As further shown in FIG. 6, in some aspects, process 600 may include selectively refraining from transmitting the signal metric based at least in part on a state of the barred cell timer (block 630). For example, the UE (e.g., using communication manager 806, depicted in FIG. 8) may selectively refrain from transmitting the signal metric based at least in part on a state of the barred cell timer, as described above.

Process 600 may include additional aspects, such as any single aspect or any combination of aspects described below and/or in connection with one or more other processes described elsewhere herein.

In a first aspect, the state of the barred cell timer is active, and selectively refraining from transmitting the signal metric includes refraining from transmitting an entirety of a measurement report associated with the measurement configuration based at least in part on the barred cell timer being active.

In a second aspect, the state of the barred cell timer is active, and selectively refraining from transmitting the signal metric includes omitting the signal metric associated with the frequency and the barred cell from a measurement report associated with the measurement configuration, and transmitting the measurement report without the signal metric associated with the frequency and the barred cell based at least in part on the barred cell timer being active.

In a third aspect, process 600 includes obtaining an indication of the barred cell, and starting the barred cell timer with a duration of T_{barred}.

In a fourth aspect, the duration is a first duration, and process 600 includes starting a time-to-trigger timer with a second duration of T_{trigger}, and the time-to-trigger timer is associated with transmitting a measurement report that is based at least in part on the measurement configuration. The fourth aspect may include computing, prior to expiration of the time-to-trigger timer, the signal metric associated with the frequency and the barred cell, receiving a first indication that the time-to-trigger timer has expired, and receiving, prior to selectively refraining from transmitting the signal metric, a second indication that the bared cell timer has expired. In the fourth aspect, selectively refraining from transmitting the signal metric includes adding the signal metric associated with the frequency and the barred cell to the measurement report based at least in part on expiration of the barred cell timer, and transmitting the measurement report with the signal metric associated with the frequency and the barred cell based at least in part on expiration of the time-to-trigger timer.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with mitigating continuous handover or redirection failure.

As shown in FIG. 7, in some aspects, process 700 may include receiving an indication of a forbidden TAC (block 710). For example, the UE (e.g., using reception component 802 and/or communication manager 806, depicted in FIG. 8) may receive an indication of a forbidden TAC, as described above.

As further shown in FIG. 7, in some aspects, process 700 may include receiving a measurement configuration that indicates to measure at least one frequency associated with a cell (block 720). For example, the UE (e.g., using reception component 802 and/or communication manager 806, depicted in FIG. 8) may receive a measurement configuration that indicates to measure at least one frequency associated with a cell, as described above.

As further shown in FIG. 7, in some aspects, process 700 may include selectively computing that a signal metric associated with the frequency and the cell satisfies a quality threshold (block 730). For example, the UE (e.g., using communication manager 806, depicted in FIG. 8) may selectively compute that a signal metric associated with the frequency and the cell satisfies a quality threshold, as described above.

As further shown in FIG. 7, in some aspects, process 700 may include refraining from transmitting the signal metric associated with the frequency and the cell based at least in part on the cell being associated with the forbidden TAC (block 740). For example, the UE (e.g., using communication manager 806, depicted in FIG. 8) may refrain from transmitting the signal metric associated with the frequency and the cell based at least in part on the cell being associated with the forbidden TAC, as described above.

Process 700 may include additional aspects, such as any single aspect or any combination of aspects described below and/or in connection with one or more other processes described elsewhere herein.

In a first aspect, receiving the indication of the forbidden TAC includes recovering the indication at a NAS layer of a protocol stack, and process 700 includes forwarding the indication to an RRC layer of the protocol stack.

In a second aspect, process 700 includes receiving, at the RRC layer of the protocol stack and from the NAS layer of the protocol stack, the indication of the forbidden TAC, and recovering, at the RRC layer of the protocol stack and based at least in part on receiving the indication from the NAS layer of the protocol stack, a SIB prior to transmitting a measurement report associated with the measurement configuration. In the second aspect, the SIB indicates an identifier associated with the signal metric (e.g., a cell identifier and/or a TAC identifier), and the indication from the NAS layer indicates that identifier is associated with the forbidden TAC.

In a third aspect, process 700 includes recovering, at an RRC layer of a protocol stack, cell context information associated with the cell, and storing, in memory at the UE, the cell context information as at least part of forbidden TAC context information.

In a fourth aspect, the cell context information includes at least one of a PCI associated with the cell, an EARFCN associated with the cell, or an ARFCN associated with the cell.

In a fifth aspect, recovering the cell context information includes recovering the cell context information based at least in part on a SIB.

In a sixth aspect, the cell context information is first cell context information, the signal metric is a first signal metric, the cell is a first cell, and process 700 includes recovering second cell context information that is associated with a potential cell, comparing the second cell context information to the forbidden TAC context information, determining, based at least in part on the comparing, that the potential cell is associated with the forbidden TAC, and refraining, based at least in part on the determining, from transmitting a second signal metric that is associated with the potential cell based at least in part on the potential cell being associated with the forbidden TAC.

In a seventh aspect, the potential cell is the first cell associated with the first cell context information.

In an eighth aspect, the potential cell is a second cell that is different from the first cell, and process 700 includes storing the second cell context information as at least part of the forbidden TAC context information.

In a ninth aspect, process 700 includes refraining, based at least in part on the determining, from generating the second signal metric that is associated with the potential cell.

In a tenth aspect, refraining from transmitting the signal metric associated with the frequency and the cell includes refraining from transmitting an entirety of a measurement report that is associated with the measurement configuration.

In an eleventh aspect, refraining from transmitting the signal metric associated with the frequency and the cell includes omitting the signal metric associated with the frequency and the cell from a measurement report that is associated with the measurement configuration, and transmitting the measurement report without the signal metric associated with the frequency and the cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 3-7. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may receive, by way of the reception component 802 and prior to expiration of a barred cell timer that is associated with a barred cell, a measurement configuration that indicates to measure a frequency that is associated with the barred cell. The communication manager 806 may compute that a signal metric associated with the frequency and the barred cell satisfies a quality threshold. The communication manager 806 may selectively refrain from transmitting the signal metric based at least in part on a state of the barred cell timer.

The communication manager may obtain, by way of the reception component 802, an indication of the barred cell.

The communication manager 806 may start the barred cell timer with a duration of T_{barred}.

Alternatively, or additionally, the communication manager 806 may receive, by way of the reception component 802, an indication of a forbidden TAC. The communication manager 806 may receive, by way of the reception component 802, a measurement configuration that indicates to measure at least one frequency associated with a cell. The communication manager 806 may selectively compute that a signal metric associated with the frequency and the cell satisfies a quality threshold. The communication manager 806 may refrain from transmitting the signal metric associated with the frequency and the cell based at least in part on the cell being associated with the forbidden TAC.

Alternatively, or additionally, the communication manager 806 may receive, at an RRC layer of a protocol stack and from a NAS layer of the protocol stack, the indication of the forbidden TAC.

Alternatively, or additionally, the communication manager 806 may recover, at the RRC layer of the protocol stack and based at least in part on receiving the indication from the NAS layer of the protocol stack, a SIB prior to transmitting a measurement report associated with the measurement configuration, the SIB indicates an identifier (e.g., a cell identifier and/or a TAC identifier) associated with the signal metric, and the indication from the NAS layer indicates that the identifier is associated with the forbidden TAC.

Alternatively, or additionally, the communication manager 806 may recover, at an RRC layer of a protocol stack, cell context information associated with the cell.

Alternatively, or additionally, the communication manager 806 may store, in memory at the UE, the cell context information as at least part of forbidden TAC context information.

Alternatively, or additionally, the communication manager 806 may refrain, based at least in part on the determining, from generating the second signal metric that is associated with the potential cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, prior to expiration of a barred cell timer that is associated with a barred cell, a measurement configuration that indicates to measure a frequency that is associated with the barred cell; computing that a signal metric associated with the frequency and the barred cell satisfies a quality threshold; and selectively refraining from transmitting the signal metric based at least in part on a state of the barred cell timer.

Aspect 2: The method of Aspect 1, wherein the state of the barred cell timer is active, and wherein selectively refraining from transmitting the signal metric comprises: refraining from transmitting an entirety of a measurement report associated with the measurement configuration based at least in part on the barred cell timer being active.

Aspect 3: The method of any of Aspects 1-2, wherein the state of the barred cell timer is active, and wherein selectively refraining from transmitting the signal metric comprises: omitting the signal metric associated with the frequency and the barred cell from a measurement report associated with the measurement configuration; and transmitting the measurement report without the signal metric associated with the frequency and the barred cell based at least in part on the barred cell timer being active.

Aspect 4: The method of any of Aspects 1-3, further comprising: obtaining an indication of the barred cell; and starting the barred cell timer with a duration of T_{barred}.

Aspect 5: The method of Aspect 4, wherein the duration is a first duration, and the method further comprises: starting a time-to-trigger timer with a second duration of T_{trigger}, wherein the time-to-trigger timer is associated with transmitting a measurement report that is based at least in part on the measurement configuration; computing, prior to expiration of the time-to-trigger timer, the signal metric associated with the frequency and the barred cell; receiving a first indication that the time-to-trigger timer has expired; and receiving, prior to selectively refraining from transmitting the signal metric, a second indication that the bared cell timer has expired; and wherein selectively refraining from transmitting the signal metric comprises: adding the signal metric associated with the frequency and the barred cell to the measurement report based at least in part on expiration of the barred cell timer; and transmitting the measurement report with the signal metric associated with the frequency and the barred cell based at least in part on expiration of the time-to-trigger timer.

Aspect 6: A method of wireless communication performed by a user equipment (UE), comprising: receiving an indication of a forbidden tracking area code (TAC); receiving a measurement configuration that indicates to measure at least one frequency associated with a cell; selectively computing that a signal metric associated with the frequency and the cell satisfies a quality threshold; and refraining from transmitting the signal metric associated with the frequency and the cell based at least in part on the cell being associated with the forbidden TAC.

Aspect 7: The method of Aspect 6, wherein receiving the indication of the forbidden TAC comprises recovering the indication at a non-stratum access (NAS) layer of a protocol stack, and the method further comprises: forwarding, by the NAS layer of the protocol stack, the indication to a radio resource control (RRC) layer of the protocol stack.

Aspect 8: The method of Aspect 7, further comprising: receiving, at the RRC layer of the protocol stack and from the NAS layer of the protocol stack, the indication of the forbidden TAC; and recovering, at the RRC layer of the protocol stack and based at least in part on receiving the indication from the NAS layer of the protocol stack, a system information block (SIB) prior to transmitting a measurement report associated with the measurement configuration, wherein the SIB indicates an identifier associated with the signal metric, and wherein the indication from the NAS layer indicates that the identifier is associated with the forbidden TAC.

Aspect 9: The method of any of Aspects 6-8, further comprising: recovering, at a radio resource control (RRC) layer of a protocol stack, cell context information associated with the cell; and storing, in memory at the UE, the cell context information as at least part of forbidden TAC context information.

Aspect 10: The method of Aspect 9, wherein the cell context information includes at least one of: a physical cell identifier (PCI) associated with the cell, an evolved universal mobile telecommunication system terrestrial radio access absolute radio frequency channel number (EARFCN) associated with the cell, or an absolute radio frequency channel number (ARFCN) associated with the cell.

Aspect 11: The method of Aspect 9, wherein recovering the cell context information comprises: recovering the cell context information based at least in part on a system information block (SIB).

Aspect 12: The method of Aspect 9, wherein the cell context information is first cell context information, the signal metric is a first signal metric, the cell is a first cell, and the method further comprises: recovering second cell context information that is associated with a potential cell; comparing the second cell context information to the forbidden TAC context information; determining, based at least in part on the comparing, that the potential cell is associated with the forbidden TAC; and refraining, based at least in part on the determining, from transmitting a second signal metric that is associated with the potential cell based at least in part on the potential cell being associated with the forbidden TAC.

Aspect 13: The method of Aspect 12, wherein the potential cell is the first cell associated with the first cell context information.

Aspect 14: The method of Aspect 12, wherein the potential cell is a second cell that is different from the first cell, and the method further comprises: storing the second cell context information as at least part of the forbidden TAC context information.

Aspect 15: The method of Aspect 12, further comprising: refraining, based at least in part on the determining, from generating the second signal metric that is associated with the potential cell.

Aspect 16: The method of any of Aspects 6-15, wherein refraining from transmitting the signal metric associated with the frequency and the cell comprises: refraining from transmitting an entirety of a measurement report that is associated with the measurement configuration.

Aspect 17: The method of any of Aspects 6-16, wherein refraining from transmitting the signal metric associated with the frequency and the cell comprises: omitting the signal metric associated with the frequency and the cell from a measurement report that is associated with the measurement configuration; and transmitting the measurement report without the signal metric associated with the frequency and the cell.

Aspect 18: An apparatus for wireless communication at a device, comprising a processor; memory coupled with the processor; and instructions stored in the memory and executable by the processor to cause the apparatus to perform the method of one or more of Aspects 1-5.

Aspect 19: An apparatus for wireless communication at a device, comprising a processor; memory coupled with the processor; and instructions stored in the memory and executable by the processor to cause the apparatus to perform the method of one or more of Aspects 6-17.

Aspect 20: A device for wireless communication, comprising a memory and one or more processors coupled to the memory, the one or more processors configured to perform the method of one or more of Aspects 1-5.

Aspect 21: A device for wireless communication, comprising a memory and one or more processors coupled to the memory, the one or more processors configured to perform the method of one or more of Aspects 6-17.

Aspect 22: An apparatus for wireless communication, comprising at least one means for performing the method of one or more of Aspects 1-5.

Aspect 23: An apparatus for wireless communication, comprising at least one means for performing the method of one or more of Aspects 6-17.

Aspect 24: A non-transitory computer-readable medium storing code for wireless communication, the code comprising instructions executable by a processor to perform the method of one or more of Aspects 1-5.

Aspect 25: A non-transitory computer-readable medium storing code for wireless communication, the code comprising instructions executable by a processor to perform the method of one or more of Aspects 6-17.

Aspect 26: A non-transitory computer-readable medium storing a set of instructions for wireless communication, the set of instructions comprising one or more instructions that, when executed by one or more processors of a device, cause the device to perform the method of one or more of Aspects 1-5.

Aspect 27: A non-transitory computer-readable medium storing a set of instructions for wireless communication, the set of instructions comprising one or more instructions that, when executed by one or more processors of a device, cause the device to perform the method of one or more of Aspects 6-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a processor;
memory coupled with the processor; and
instructions stored in the memory and executable by the processor to cause the apparatus to:
receive, prior to expiration of a barred cell timer that is associated with a barred cell, a measurement configuration that indicates to measure a frequency that is associated with the barred cell;
compute that a signal metric associated with the frequency and the barred cell satisfies a quality threshold; and
selectively refrain from transmitting the signal metric based at least in part on a state of the barred cell timer.

2. The apparatus of claim 1, wherein the state of the barred cell timer is active, and
wherein the instructions, to cause the apparatus to selectively refrain from transmitting the signal metric, cause the apparatus to:
refrain from transmitting an entirety of a measurement report associated with the measurement configuration based at least in part on the barred cell timer being active.

3. The apparatus of claim 1, wherein the state of the barred cell timer is active, and
wherein the instructions, to cause the apparatus to selectively refrain from transmitting the signal metric, cause the apparatus to:
omit the signal metric associated with the frequency and the barred cell from a measurement report associated with the measurement configuration; and
transmit the measurement report without the signal metric associated with the frequency and the barred cell based at least in part on the barred cell timer being active.

4. The apparatus of claim 1, wherein the instructions further cause the apparatus to:
obtain an indication of the barred cell; and
start the barred cell timer with a duration of T_{barred}.

5. The apparatus of claim 4, wherein the instructions further cause the apparatus to:
start a time-to-trigger timer with a second duration of T_{trigger}, wherein the time-to-trigger timer is associated with transmitting a measurement report that is based at least in part on the measurement configuration;
compute, prior to expiration of the time-to-trigger timer, the signal metric associated with the frequency and the barred cell;
receive a first indication that the time-to-trigger timer has expired; and
receive, prior to a determination to selectively refrain from transmitting the signal metric, a second indication that the bared cell timer has expired; and
wherein the instructions, to cause the apparatus to selectively refrain from transmitting the signal metric, cause the apparatus to:
add the signal metric associated with the frequency and the barred cell to the measurement report based at least in part on expiration of the barred cell timer; and
transmit the measurement report with the signal metric associated with the frequency and the barred cell based at least in part on expiration of the time-to-trigger timer.

6. An apparatus for wireless communications at a user equipment (UE), comprising:
a processor;
memory; and
instructions stored in the memory and executable by the processor to cause the apparatus to:
receive an indication of a forbidden tracking area code (TAC);
receive a measurement configuration that indicates to measure at least one frequency associated with a cell;
selectively compute that a signal metric associated with the frequency and the cell satisfies a quality threshold; and
refrain from transmitting the signal metric associated with the frequency and the cell based at least in part on the cell being associated with the forbidden TAC.

7. The apparatus of claim 6, wherein the instructions, to cause the apparatus to receive the indication of the forbidden TAC, cause the apparatus to recover the indication at a non-stratum access (NAS) layer of a protocol stack, and
wherein the instructions further cause the apparatus to:
forward, by the NAS layer of the protocol stack, the indication to a radio resource control (RRC) layer of the protocol stack.

8. The apparatus of claim 7, wherein the instructions further cause the apparatus to:
receive, at the RRC layer of the protocol stack and from the NAS layer of the protocol stack, the indication of the forbidden TAC; and
recover, at the RRC layer of the protocol stack and based at least in part on receiving the indication from the NAS layer of the protocol stack, a system information block (SIB) prior to transmitting a measurement report associated with the measurement configuration,
wherein the SIB indicates an identifier associated with the signal metric, and
wherein the indication from the NAS layer indicates that the identifier is associated with the forbidden TAC.

9. The apparatus of claim 6, wherein the instructions further cause the apparatus to:
recover, at a radio resource control (RRC) layer of a protocol stack, cell context information associated with the cell; and
store, in memory at the UE, the cell context information as at least part of forbidden TAC context information.

10. The apparatus of claim 9, wherein the instructions, to cause the apparatus to recover the cell context information, cause the apparatus to:
recover the cell context information based at least in part on a system information block (SIB).

11. The apparatus of claim 9, wherein the instructions further cause the apparatus to:
recover second cell context information that is associated with a potential cell;
compare the second cell context information to the forbidden TAC context information;
determine, based at least in part on a comparison of the second cell context information to the forbidden TAC context information, that the potential cell is associated with the forbidden TAC; and
refrain, based at least in part on a determination that the potential cell is associated with the forbidden TAC, from transmitting a second signal metric that is associated with the potential cell based at least in part on the potential cell being associated with the forbidden TAC.

12. The apparatus of claim 11, wherein the instructions further cause the apparatus to:
store the second cell context information as at least part of the forbidden TAC context information.

13. The apparatus of claim 11, wherein the instructions further cause the apparatus to:
refrain, based at least in part on the determination that the potential cell is associated with the forbidden TAC, from generating the second signal metric that is associated with the potential cell.

14. The apparatus of claim 6, wherein the instructions, to cause the apparatus to refrain from transmitting the signal metric associated with the frequency and the cell, cause the apparatus to:
refrain from transmitting an entirety of a measurement report that is associated with the measurement configuration.

15. The apparatus of claim 6, wherein the instructions, to cause the apparatus to refrain from transmitting the signal metric associated with the frequency and the cell, cause the apparatus to:
omit the signal metric associated with the frequency and the cell from a measurement report that is associated with the measurement configuration; and
transmit the measurement report without the signal metric associated with the frequency and the cell.

16. A method of wireless communication performed by a user equipment (UE), comprising:
receiving, prior to expiration of a barred cell timer that is associated with a barred cell, a measurement configuration that indicates to measure a frequency that is associated with the barred cell;
computing that a signal metric associated with the frequency and the barred cell satisfies a quality threshold; and
selectively refraining from transmitting the signal metric based at least in part on a state of the barred cell timer.

17. The method of claim 16, wherein the state of the barred cell timer is active, and
wherein selectively refraining from transmitting the signal metric comprises:
refraining from transmitting an entirety of a measurement report associated with the measurement configuration based at least in part on the barred cell timer being active.

18. The method of claim 16, wherein the state of the barred cell timer is active, and
wherein selectively refraining from transmitting the signal metric comprises:
omitting the signal metric associated with the frequency and the barred cell from a measurement report associated with the measurement configuration; and
transmitting the measurement report without the signal metric associated with the frequency and the barred cell based at least in part on the barred cell timer being active.

19. The method of claim 16, further comprising:
obtaining an indication of the barred cell; and
starting the barred cell timer with a duration of T_{barred}.

20. The method of claim 19, wherein the duration is a first duration, and the method further comprises:
starting a time-to-trigger timer with a second duration of T_{trigger}, wherein the time-to-trigger timer is associated with transmitting a measurement report that is based at least in part on the measurement configuration;
computing, prior to expiration of the time-to-trigger timer, the signal metric associated with the frequency and the barred cell;
receiving a first indication that the time-to-trigger timer has expired; and
receiving, prior to selectively refraining from transmitting the signal metric, a second indication that the bared cell timer has expired; and
wherein selectively refraining from transmitting the signal metric comprises:
adding the signal metric associated with the frequency and the barred cell to the measurement report based at least in part on expiration of the barred cell timer; and
transmitting the measurement report with the signal metric associated with the frequency and the barred cell based at least in part on expiration of the time-to-trigger timer.

21. A method of wireless communication performed by a user equipment (UE), comprising:
receiving an indication of a forbidden tracking area code (TAC);
receiving a measurement configuration that indicates to measure at least one frequency associated with a cell;
selectively computing that a signal metric associated with the frequency and the cell satisfies a quality threshold; and
refraining from transmitting the signal metric associated with the frequency and the cell based at least in part on the cell being associated with the forbidden TAC.

22. The method of claim 21, wherein receiving the indication of the forbidden TAC comprises recovering the indication at a non-stratum access (NAS) layer of a protocol stack, and the method further comprises:
forwarding, by the NAS layer of the protocol stack, the indication to a radio resource control (RRC) layer of the protocol stack.

23. The method of claim 22, further comprising:
receiving, at the RRC layer of the protocol stack and from the NAS layer of the protocol stack, the indication of the forbidden TAC; and
recovering, at the RRC layer of the protocol stack and based at least in part on receiving the indication from the NAS layer of the protocol stack, a system information block (SIB) prior to transmitting a measurement report associated with the measurement configuration,
wherein the SIB indicates an identifier associated with the signal metric, and
wherein the indication from the NAS layer indicates that the identifier is associated with the forbidden TAC.

24. The method of claim 21, further comprising:
recovering, at a radio resource control (RRC) layer of a protocol stack, cell context information associated with the cell; and
storing, in memory at the UE, the cell context information as at least part of forbidden TAC context information.

25. The method of claim 24, wherein recovering the cell context information comprises:
recovering the cell context information based at least in part on a system information block (SIB).

26. The method of claim 24, wherein the cell context information is first cell context information, the signal metric is a first signal metric, the cell is a first cell, and the method further comprises:
recovering second cell context information that is associated with a potential cell;
comparing the second cell context information to the forbidden TAC context information;
determining, based at least in part on the comparing, that the potential cell is associated with the forbidden TAC; and
refraining, based at least in part on the determining, from transmitting a second signal metric that is associated with the potential cell based at least in part on the potential cell being associated with the forbidden TAC.

27. The method of claim 26, wherein the potential cell is a second cell that is different from the first cell, and the method further comprises:
storing the second cell context information as at least part of the forbidden TAC context information.

28. The method of claim 26, further comprising:
refraining, based at least in part on the determining, from generating the second signal metric that is associated with the potential cell.

29. The method of claim 21, wherein refraining from transmitting the signal metric associated with the frequency and the cell comprises:
refraining from transmitting an entirety of a measurement report that is associated with the measurement configuration.

30. The method of claim 21, wherein refraining from transmitting the signal metric associated with the frequency and the cell comprises:
omitting the signal metric associated with the frequency and the cell from a measurement report that is associated with the measurement configuration; and
transmitting the measurement report without the signal metric associated with the frequency and the cell.
